(19) United States
(12) Patent Application Publication
(10) Pub. No.: US 2025/0313073 A1
(43) Pub. Date: Oct. 9, 2025

(54) AUTOMOTIVE COOLANT SUPPLY DEVICE

(71) Applicant: PIERBURG PUMP TECHNOLOGY GMBH, NEUSS (DE)

(72) Inventors: MARCO LIMBACH, NEUSS (DE); DUCCIO GRIFFINI, LIVORNO (IT); JOSEPH HONSTAIN, AUBURN HILLS, MI (US); GREGORY NOLAN, AUBURN HILLS, MI (US)

(73) Assignee: PIERBURG PUMP TECHNOLOGY GMBH, NEUSS (DE)

(21) Appl. No.: 18/865,688

(22) PCT Filed: May 17, 2022
(86) PCT No.: PCT/EP2022/063327

§ 371 Date: Nov. 14, 2024

(51) Int. Cl. B60K 1/00

(52) U.S. Cl. CPC B60K 1/00; B60K 2001/005; B60K 2001/006

(57) ABSTRACT

An automotive coolant supply device includes a traction battery coolant supply chamber, a traction motor coolant supply chamber which is separate from the traction battery coolant supply chamber, and a flow restrictor element which is arranged within the automotive coolant supply device. The flow restrictor element fluidically connects the traction battery coolant supply chamber and the traction motor coolant supply chamber. The flow restrictor element has a separating wall which is arranged between the traction battery coolant supply chamber and the traction motor coolant supply chamber, and a connection passage which is arranged within the separating wall.

### CROSS REFERENCE TO PRIOR APPLICATIONS

This application is a U.S. National Phase application under 35 U.S.C. § 371 of International Application No. PCT/EP2022/063327, filed on May 17, 2022. The International Application was published in English on Nov. 23, 2023 as WO 2023/222201 A1 under PCT Article 21(2).

### FIELD

The present invention is directed to an automotive coolant supply device, in particular to a flow restrictor element for an automotive coolant supply device.

### BACKGROUND

State-of-the-art battery electric vehicles can be provided with high voltage power systems comprising, for example, a high-voltage traction motor for driving the battery electric vehicle and a high-voltage traction battery as an electrical energy storage. The essential components of the high-voltage power system, in particular the high-voltage traction battery and the high-voltage drive motor, are extremely thermally loaded during their operation so that an efficient active cooling system is necessary to avoid an overheating of the high-voltage power system components.

Such a cooling system typically comprises separate cooling circuits for the high-voltage traction battery and the high-voltage traction motor, respectively. Each cooling circuit is provided with coolant which circulates within the cooling circuit and thereby dissipates the heat being generated by the high-voltage power system components. An automotive coolant supply device can be applied to combine several auxiliary components of the cooling circuits, for example, pumps or valves, in a single assembly unit which can be mounted to the vehicle in one single process step. An automotive coolant supply device also allows the fluidic connection of the cooling circuits to each other, thereby allowing the application of one single coolant expansion reservoir for all cooling circuits.

The difficulty in fluidically connecting two coolant circuits is to allow a coolant exchange between the connected circuits for pressure equalization while avoiding a temperature approximation of the coolant circuits by exchanging heat therebetween. Conventional flow restrictor elements for reducing a volume flow within different types of fluid systems are well-known but are not configured to define a heat barrier.

### SUMMARY

An aspect of the present invention is to provide a flow restrictor element which allows the exchange of coolant between two fluidically connected coolant circuits within an automotive coolant supply device for pressure equalization, wherein the flow restrictor element minimizes the heat exchange between the coolant circuits.

In an embodiment, the present invention provides an automotive coolant supply device which includes a traction battery coolant supply chamber, a traction motor coolant supply chamber which is separate from the traction battery coolant supply chamber, and a flow restrictor element which is arranged within the automotive coolant supply device. The flow restrictor element is configured to fluidically connect the traction battery coolant supply chamber and the traction motor coolant supply chamber. The flow restrictor element comprises a separating wall which is arranged between the traction battery coolant supply chamber and the traction motor coolant supply chamber, and a connection passage which is arranged within the separating wall.

### BRIEF DESCRIPTION OF THE DRAWINGS

The present invention is described in greater detail below on the basis of embodiments and of the drawings in which:

FIG. 1 shows a first embodiment of an automotive coolant supply device according to the present invention in a schematic longitudinal cross-sectional view;

FIG. 2 shows a transversal cross-sectional view through the coolant passage and through the traction battery coolant supply chamber of the automotive coolant supply device of FIG. 1;

FIG. 3 shows a second embodiment of an automotive coolant supply device according to the present invention in a schematic longitudinal cross-sectional view; and

FIG. 4 shows a transversal cross-sectional view through the coolant passage and through the traction battery coolant supply chamber of the automotive coolant supply device of FIG. 3.

### DETAILED DESCRIPTION

The automotive coolant supply device according to the present invention comprises a traction battery coolant supply chamber which is, for example, connectable to a traction battery coolant circuit for cooling and heating a traction battery of a battery electric vehicle so that the traction battery coolant supply chamber would be part of the traction battery coolant circuit. The automotive coolant supply device further comprises a separate traction motor coolant supply chamber which can, for example, be connectable to a traction motor coolant circuit for cooling and heating a traction motor of a battery electric vehicle so that the traction motor coolant supply chamber would be part of the traction motor coolant circuit.

The automotive coolant supply device further comprises a flow restrictor element which fluidically connects the traction battery coolant supply chamber and the traction motor coolant supply chamber within the automotive coolant supply device in a flow restricting manner. The automotive coolant supply device comprises a separating wall which is arranged between the traction battery coolant supply chamber and the traction motor coolant supply chamber, the separating wall thereby defining a type of fluidic barrier between both coolant supply chambers. The flow restrictor element defines a connection passage within the separating wall which fluidically connects the traction battery coolant supply chamber and the traction motor coolant supply chamber. The fluidic connection of the traction battery coolant supply chamber and the traction motor coolant supply chamber allows one single coolant expansion reservoir to be applied for both fluidically connected coolant circuits which is advantageous in that it provides a compact and space-saving arrangement of the complete coolant system.

The function of the flow restrictor element is to only allow a relatively low coolant exchange between both fluidically connected coolant supply chambers and to thereby only allow a relatively low coolant exchange between both coolant circuits. The heat exchange between the coolant circuits is restricted as a result of the relatively low coolant exchange between the traction battery coolant supply chamber and the traction motor coolant supply chamber so that no relevant heat transfer exists between the coolants within each coolant supply chamber. The coolant within each coolant supply chamber accordingly has an individual temperature level which is not relevantly affected by the coolant within the other coolant supply chamber.

In an embodiment of the present invention, a cross-sectional area of the connection passage can, for example, be at least 50% smaller than a cross-sectional area of each coolant supply chamber. The cross-sectional areas referred to can, for example, lie within a single plane which is located adjacent to the separating wall and which is parallel to the separating wall. The relatively small cross-sectional area of the connection passage provides a sufficient flow restriction between the traction battery coolant supply chamber and the traction motor coolant supply chamber to effectively restrict the convective heat exchange between the coolant circuits being fluidically connected by the connection passage.

In an embodiment of the present invention, the connection passage can, for example, be provided with a circular cross-section so that the connection passage can, for example, be cylindrical. The cylindrical shape of the connection passage results in a nearly turbulence-free and relatively homogeneous flow profile within the connection passage for minimizing the convective heat transfer.

In an embodiment of the present invention, the flow restrictor element can, for example, comprise a tube-shaped section which extends from the separating wall. The tube-shaped section can, for example, be straight, i.e., if the cross-section of the connection passage is, for example, circular, the tube-shaped section can, for example, be a hollow-cylindrical or circular tube. The cross-section of the connection passage can alternatively be rectangular so that the tube-shaped section is in that case a rectangular tube. The cross-section of the connection passage can alternatively be defined by every other suitable geometry which serves the purpose of a flow restricting element. The shape of the connection passage and the shape of the tube-shaped section can furthermore be identical or different. The zone where the coolant of the traction battery coolant supply chamber and the coolant of the traction motor supply chamber come together is defined as confluence zone. The confluence zone is ideally defined within the tube-shaped section which mainly depends on the length of the tube-shaped section in relation to the cross-sectional area of the tube-shaped section.

In an embodiment of the present invention, the tube-shaped section can, for example, protrude from the separating wall into at least one coolant supply chamber. In an embodiment of the present invention, the tube-shaped section can, for example, protrude from the separating wall into both coolant supply chambers, wherein each protrusion can, for example, be larger than 10 mm. The lengths of each protrusion can be identical or, alternatively, can be different. The protrusion of the tube-shaped section into each coolant supply chamber allows a relatively large length of the tube-shaped section to be provided, but also allows a relatively thin separating wall to be provided between the traction motor coolant supply chamber and the traction battery coolant supply chamber. The combination of a relatively thin separating wall and a protrusion into each coolant supply chamber results in defining low-flow zones adjacent to the separating wall at the outside of the protrusions so that a convective heat transfer from the coolant to the separating wall or vice versa is relatively low.

In an embodiment of the present invention, the length of the tube-shaped section can, for example, be at least as large as the width of the tube-shaped section, i.e., if the width of the tube-shaped section is, for example, 15 mm, the length of the tube-shaped section is at least 15 mm. The confluence zone between the coolants of each coolant supply chamber is thereby arranged within the tube-shaped section so that the heat transfer between the traction battery coolant supply chamber and the traction motor coolant supply chamber via the coolant is extremely low.

In an embodiment of the present invention, the volume of the tube-shaped section can, for example, be larger than or equal to 5000 mm³. A specific ratio between the width and the length of the tube-shaped section is thereby defined so that, depending on the width, the corresponding length can be easily calculated to provide the confluence zone to be within the tube-shaped section. The confluence zone is in motion depending on temperature-caused coolant volume differences within each coolant circuit. The tube-shaped section should therefore be provided with a specific length that is large enough to keep the motion of the confluence zone within the tube-shaped section so that the confluence zone always remains within the tube-shaped section.

In an embodiment of the present invention, the tube-shaped section can, for example, be provided with a shielding wall for shielding the connection passage against a coolant inlet port and/or a coolant outlet port of the traction battery coolant supply chamber and/or a coolant inlet port and/or a coolant outlet port of the traction motor coolant supply chamber. The shielding wall can, for example, be arranged so that the coolant inflow into the supply chambers or the coolant outflow out of the supply chambers does not directly bypass an opening of the tube-shaped section. An entering of the coolant into the tube-shaped section is thereby avoided. The appearance of turbulences at the openings of the tube-shaped section is furthermore substantially avoided so that a convective heat transfer between the traction battery coolant supply chamber and the traction motor coolant supply chamber is minimized.

In an embodiment of the present invention, the shielding wall can, for example, comprise one or more shielding wall sections. The shielding wall can, for example, comprise a first shielding wall section and a second shielding wall section, wherein the second shielding wall section extends from the first shielding wall section under a defined angle. This angle can be between 10° and 170°, for example, 90°. A type of labyrinth sealing is thereby defined which additionally increases the shielding effect compared to one single shielding wall section. The opening of the tube-shaped section is thereby arranged at that end of the tube-shaped section which is remote to the corresponding coolant port.

In an embodiment of the present invention, during operation, the coolant within both coolant supply chambers can, for example, be at atmospheric pressure, thereby resulting in a relatively simple sealing of the coolant system. The equal atmospheric pressure within both coolant supply chambers furthermore makes possible a fluidic connection of the coolant supply chambers to provide one single coolant expansion reservoir.

Two embodiments of the present invention are described below with reference to the drawings.

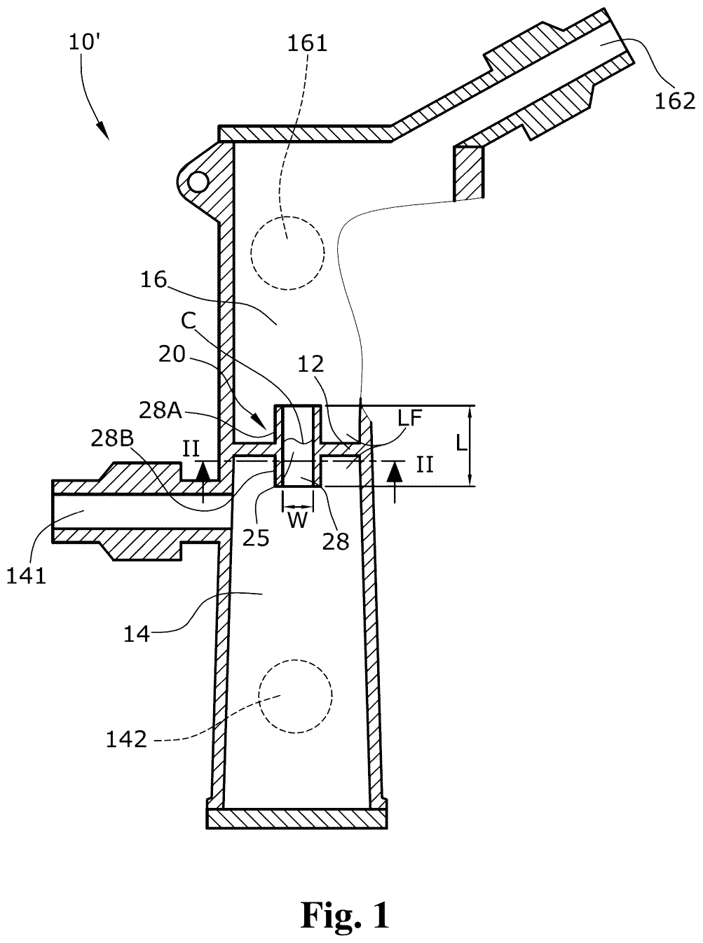

FIG. 1 shows an automotive coolant supply device 10 of a battery electric vehicle. The automotive coolant supply device 10 comprises a substantially cuboid traction battery coolant supply chamber 14 with a coolant inlet port 141 and a coolant outlet port 142 (the latter being indicated by the dashed circle). The traction battery coolant supply chamber 14 is thereby connectable to a traction battery coolant circuit of the battery electric vehicle. The automotive coolant supply device 10 further comprises a traction motor coolant supply chamber 16 which is only partly shown. The traction motor coolant supply chamber 16 comprises a coolant inlet port 162 and a coolant outlet port 161 (the latter being indicated by the dashed circle). The traction motor coolant supply chamber 16 is thereby fluidically connectable to a traction motor coolant circuit of the battery electric vehicle. As a result, each coolant supply chamber 14, 16 is part of one separate coolant circuit of the battery electric vehicle.

The traction motor coolant supply chamber 16 is fluidically connected to the traction battery coolant supply chamber 14 by a flow restrictor element 20 which defines a connection passage 25 within a relatively thin separating wall 12. The pressure within both the traction battery coolant supply chamber 14 and the traction motor coolant supply chamber 16 is equal and is, during operation, substantially at an over-atmospheric pressure level, wherein the absolute pressure is about 1.65 bar. The flow restrictor element 20 only allows a relatively low coolant exchange between the traction battery coolant supply chamber 14 and the traction motor coolant supply chamber 16. The flow restrictor element 20 also restricts the convective heat exchange between the coolant of the traction battery coolant supply chamber 14 and the coolant of the traction motor coolant supply chamber 16. The temperature levels of the fluidically connected coolant circuits therefore do not relevantly affect each other so that every coolant circuit can be provided with an individual temperature level.

The separating wall 12 is arranged between the traction motor coolant supply chamber 16 and the traction battery coolant supply chamber 14. The flow restrictor element 20 comprises a cylindrical tube-shaped section 28 which extends from the separating wall 12, wherein the tube-shaped section 28 comprises a first hollow-cylindrical protrusion 28A protruding from the separating wall 12 into the traction motor coolant supply chamber 16 and a second hollow-cylindrical protrusion 28B protruding into the traction battery coolant supply chamber 14. The connection passage 25 is provided with a circular cross-section with a width W, i.e., with a diameter of 15 mm. The first holly-cylindrical protrusion 28A of the tube-shaped section 28 extending into the traction motor coolant supply chamber 16 is provided with a length of 18 mm, wherein the second hollow-cylindrical protrusion 28B extending into the traction battery coolant supply chamber 14 is provided with a length of 22 mm. The length L of the tube-shaped section 28 or of the connection passage 25 is 40 mm in total. This results in a total volume of the connection passage 25 of 7068.6 mm³.

The protrusions 28A, 28B define ring-shaped low-flow zones LF adjacent to the separating wall 12 surrounding the tube-shaped section 28, each low-flow zone LF defining a zone with a relatively low convective heat transfer between the coolant and the separating wall 12 which additionally restricts the heat transfer between the traction battery coolant supply chamber 14 and the traction motor coolant supply chamber 16.

A confluence zone C is defined within the connection passage 25, the confluence zone C being that zone where the coolant of the traction battery coolant supply chamber 14 and the coolant of the traction motor coolant supply chamber 16 come together. The confluence zone C is in motion depending on temperature-caused volume differences. According to the width-to-length-ratio of the connection passage 25, the confluence zone C is kept within the connection passage 25 so that the heat exchange surface and thereby the convective heat exchange between the coolant of the traction battery coolant supply chamber 14 and the coolant of the traction motor coolant supply chamber 16 is extremely low.

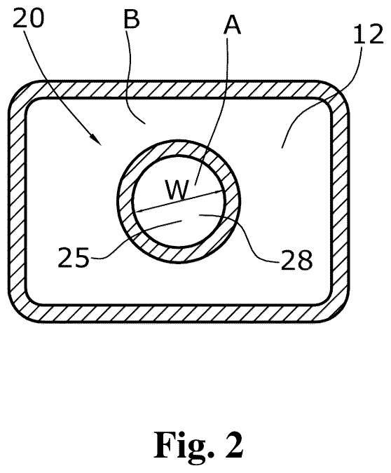

FIG. 2 shows a cross-sectional area A of the connection passage 25 and a cross-sectional area B of the traction battery coolant supply chamber 14 adjacent to the separating wall 12. The cross-sectional area A of the connection passage 25 is more than 50% smaller than the cross-sectional area B of the traction battery coolant supply chamber 14 which provides a relatively low coolant and heat exchange between the coolant supply chambers 14, 16, but allows one single common coolant expansion reservoir to be applied for both coolant circuits of the battery electric vehicle.

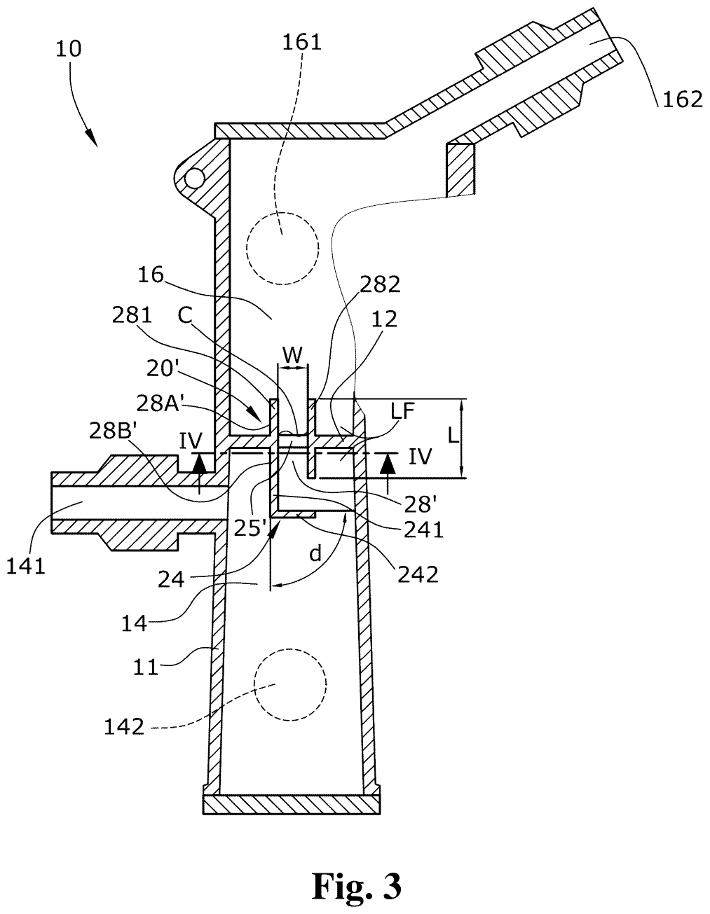

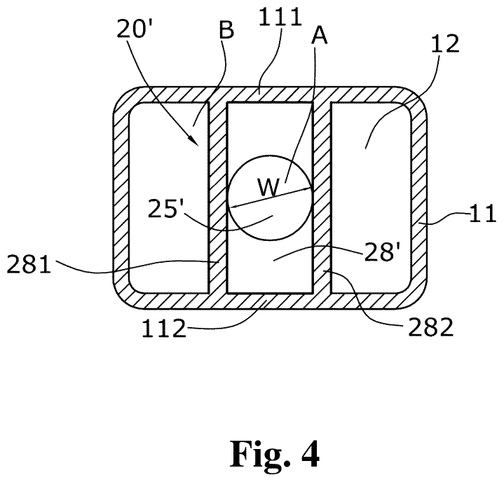

Compared to FIGS. 1 and 2, FIGS. 3 and 4 show an automotive coolant supply device 10′ of a battery electric vehicle with an alternative flow restrictor element 20′. All other features of FIGS. 3 and 4 which are not mentioned are equivalent to FIGS. 1 and 2. The flow restrictor element 20′ comprises a circular connection passage 25′ within the separating wall 12, the connection passage 25′ having a width W of 15 mm. The flow restrictor element 20′ further comprises a rectangular tube-shaped section 28′ with a first protrusion 28A′ protruding into the traction motor coolant supply chamber 16 and a second protrusion protruding into the traction battery coolant supply chamber 14. As shown in FIG. 4, each protrusion 28A′, 28B′ is defined by a first inner planar tube sidewall 281, by a second inner planar tube sidewall 282 which is parallel to the first inner planar tube sidewall 281, by a first outer wall section 111, and by a second outer wall section 112, wherein the first outer wall section 111 and the second outer wall section 112 are part of the outer shell 11 of the automotive coolant supply device 10′.

The tube-shaped section 28′ is provided with a shielding wall 24 which comprises a planar first shielding wall section 241 extending from and being parallel to the first inner planar tube sidewall 281 of the second protrusion 28B′, and a planar second shielding wall section 242 which extends from the distal end of the first shielding wall section 241 under an angle d of 90° substantially towards the second inner planer tube sidewall 282 of the second protrusion 28B′, shown in FIG. 3. The first shielding wall section 241 thereby shields the coolant inlet port 141 of the traction battery coolant supply chamber 14 so that the coolant flowing in through the coolant inlet port 141 does not directly bypass the connection passage 25′ or the traction-battery-coolant-supply-chamber-sided opening of the tube-shaped section 28′. The second shielding wall section 242 additionally shields the connection passage 25′ and the traction-battery-coolant-supply-chamber-sided opening of the tube-shaped section 28′ by defining a type of labyrinth. A convective heat transfer between the coolant inflow from the coolant inlet port 141 and the coolant being within the tube-shaped section 28′ is thereby minimized.

The present invention is not limited to embodiments described herein; reference should be had to the appended claims.

### LIST OF REFERENCE CHARACTERS

10 Automotive coolant supply device
10′ Automotive coolant supply device
11 Outer shell
12 Separating wall
14 Traction battery coolant supply chamber
16 Traction motor coolant supply chamber
20 Flow restrictor element
20 Flow restrictor element
24 Shielding wall
25 Connection passage
25′ Connection passage
28 (Cylindrical) Tube-shaped section
28′ (Rectangular) Tube-shaped section
28A First hollow-cylindrical protrusion
28A′ First protrusion
28B Second hollow-cylindrical protrusion
28B′ Second protrusion
111 First outer wall section
112 Second outer wall section
141 Coolant inlet port
142 Coolant outlet port
161 Coolant outlet port
162 Coolant inlet port
241 First shielding wall section
242 Second shielding wall section
281 First inner planar tube sidewall
282 Second inner planer tube sidewall
A Cross-sectional area of connection passage 25
B Cross-sectional area of traction battery coolant supply chamber 14
C Confluence zone
d Angle
L Length of tube-shaped section 28 or of connection passage 25
LF Ring-shaped low-flow zones
W Width

What is claimed is:

1-9. (canceled)

10. An automotive coolant supply device comprising:
a traction battery coolant supply chamber;
a traction motor coolant supply chamber which is separate from the traction battery coolant supply chamber; and
a flow restrictor element which is arranged within the automotive coolant supply device, the flow restrictor element being configured to fluidically connect the traction battery coolant supply chamber and the traction motor coolant supply chamber, the flow restrictor element comprising a separating wall which is arranged between the traction battery coolant supply chamber and the traction motor coolant supply chamber, and a connection passage which is arranged within the separating wall.

11. The automotive coolant supply device as recited in claim 10, wherein,
the traction battery coolant supply chamber has a traction battery coolant supply chamber cross-sectional area which is adjacent to the separation wall,
the traction motor coolant supply chamber has a traction motor coolant supply chamber cross-sectional area which is adjacent to the separation wall,
the connection passage has a cross-sectional area, and
the cross-sectional area of the connection passage is at least 50% smaller than each of the traction battery coolant supply chamber cross-sectional area and the traction motor coolant supply chamber cross-sectional area.

12. The automotive coolant supply device as recited in claim 10, wherein the connection passage has a circular cross-section.

13. The automotive coolant supply device as recited in claim 10, wherein the flow restrictor element further comprises a tube-shaped section which extends from the separating wall.

14. The automotive coolant supply device as recited in claim 13, wherein the tube-shaped section is arranged to be straight.

15. The automotive coolant supply device as recited in claim 13, wherein the tube-shaped section is arranged to protrude from the separating wall into at least one of the traction battery coolant supply chamber and the traction motor coolant supply chamber.

16. The automotive coolant supply device as recited in claim 15, wherein each protrusion is larger than 10 mm.

17. The automotive coolant supply device as recited in claim 13, wherein the tube-shaped section is arranged to protrude from the separating wall into each of the traction battery coolant supply chamber and the traction motor coolant supply chamber.

18. The automotive coolant supply device as recited in claim 17, wherein each protrusion is larger than 10 mm.

19. The automotive coolant supply device as recited in claim 13, wherein,
the tube-shaped section has a length and a width, and
the length of the tube-shaped section is at least as large as the width of the tube-shaped section.

20. The automotive coolant supply device as recited in claim 13, wherein the tube-shaped section has a volume which is larger than or equal to 5000 mm³.

21. The automotive coolant supply device as recited in claim 13, wherein,
the traction battery coolant supply chamber comprises at least one of a coolant inlet port and a coolant outlet port,
the traction motor coolant supply chamber comprises at least one of a coolant inlet port and a coolant outlet port, and
the tube-shaped section comprises a shielding wall which is configured to shield the connection passage against at least one of,
the coolant inlet port of the traction battery coolant supply chamber,
the coolant outlet port of the traction battery coolant supply chamber,
the coolant inlet port of the traction motor coolant supply chamber, and
the coolant outlet port of the traction motor coolant supply chamber.

22. The automotive coolant supply device as recited in claim 21, wherein the shielding wall comprises at least one shielding wall section.

23. The automotive coolant supply device as recited in claim 22, wherein,
the at least one shielding wall section is provided as a first shielding wall section and a second shielding wall section, and
the second shielding wall section is arranged to extend from the first shielding wall section at an angle of between 10° and 170°.
